(19) United States
(12) Patent Application Publication
(10) Pub. No.: US 2017/0128300 A1
(43) Pub. Date: May 11, 2017

(54) INFANT CARE SYSTEM

(71) Applicant: General Electric Company, Schenectady, NY (US)

(72) Inventors: Ravi Kumar, Bangalore (IN); Santhosh Kumar Ramachandran Nair, Bangalore (IN)

(21) Appl. No.: 15/318,605

(22) PCT Filed: Jun. 16, 2015
(86) PCT No.: PCT/US15/35996

§ 371 Date: Dec. 13, 2016

(30) Foreign Application Priority Data
Jun. 30, 2014 (IN) 3201/CHE/2014

(51) Int. Cl. A61G 11/00

(52) U.S. Cl. CPC A61G 11/00; A61G 2210/90

(57) ABSTRACT

An infant care system for warming infants is disclosed. The infant care system comprises a supporting structure and an infant enclosure. The infant enclosure is assembled onto the supporting structure and capable of holding an infant. The infant enclosure includes a plurality of walls for forming the enclosure. The plurality of walls is capable of providing heat energy into the infant enclosure for the infant. An electric source is electrically connected to the plurality of walls for providing power to these walls for generating the heat energy for warming the infant.

### FIELD OF THE INVENTION

The subject matter disclosed herein relates to providing care by warming of infants. More specifically the subject matter relates to an infant care system for warming infants.

### BACKGROUND OF THE INVENTION

Infant care systems are used to provide warmth to infants at a set desired temperature. A heating source such as a heating rod is present to heat an infant holding unit of the infant warming apparatus where the infant is positioned. Different types and shapes of heating source may be used and this heating source when heated radiates the heat rays towards a reflector positioned in a close proximity of the heating source. The reflector reflects heat rays falling on it towards the infant to provide regulated heating to infant. As the temperature of the heat source can be very high, there is always a possibility that a casing to hold or cover the reflector and heating source gets heated and which may result in injuring an operator or caregiver of the infant warming apparatus if the temperature of casing is not maintained below a specified limit. The casing may be composed of a plastic material or metal and gets heated up due to thermal conduction and convection heat transfer. Normally the infant warming canopies are bulky in size to increase the heat transfer and to dissipate more heat and thus increasing the weight and cost of the infant warming apparatus. The casing may also need to be moved in some instances for performing other tests such as x-ray imaging on the infant. So if the casing is heated up then movement of the casing by the operator may be difficult. Furthermore heat loss occurs when the heat waves reach an infant bed from the heating source.

Accordingly, a need exists for an improved system for warming the infants with a simple and convenient structure for the operator.

### SUMMARY OF THE INVENTION

The object of the invention is to provide a system for infant care system for warming infants, which overcomes one or more drawbacks of the prior art. This is achieved by an infant care system for warming infants with a simple and convenient design as defined in the independent claim.

One advantage with the disclosed infant care system is that it can provide heat for warming the infants without a heat source i.e. a heating rod provided in a heater canopy. As the heater canopy is avoided the infant can be accessed by the operator or attendant conveniently and other medical devices such as an x-ray device can be used for taking x-ray images from infant.

In an embodiment an infant care system for warming infants is disclosed. The infant care system comprises a supporting structure and an infant enclosure. The infant enclosure is assembled onto the supporting structure and capable of holding an infant. The infant enclosure includes a plurality of walls for forming the enclosure. The plurality of walls is capable of providing heat energy into the infant enclosure for the infant. An electric source is electrically connected to the plurality of walls for providing power to these walls for generating the heat energy for warming the infant.

A more complete understanding of the present invention, as well as further features and advantages thereof, will be obtained by reference to the following detailed description and drawings.

### BRIEF DESCRIPTION OF THE DRAWINGS

FIG. 1 is a schematic illustration of a perspective view of an infant care system in accordance with an embodiment;

FIG. 2 is a schematic illustration of an infant care system according to an embodiment;

FIG. 3 is a schematic illustration of an exemplary wall of the infant care system of FIG. 2 in accordance to an embodiment; and

FIG. 4 is a schematic illustration an incubator configured to house an infant, such as a premature infant, is illustrated according to an exemplary embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical and other changes may be made without departing from the scope of the embodiments. The following detailed description is, therefore, not to be taken as limiting the scope of the invention.

As discussed in detail below, embodiments of an infant care system for warming infants is disclosed. The infant care system comprises a supporting structure and an infant enclosure. The infant enclosure is assembled onto the supporting structure and capable of holding an infant. The infant enclosure includes a plurality of walls for forming the enclosure. The plurality of walls is capable of providing heat energy into the infant enclosure for the infant. An electric source is electrically connected to the plurality of walls for providing power to these walls for generating the heat energy for warming the infant.

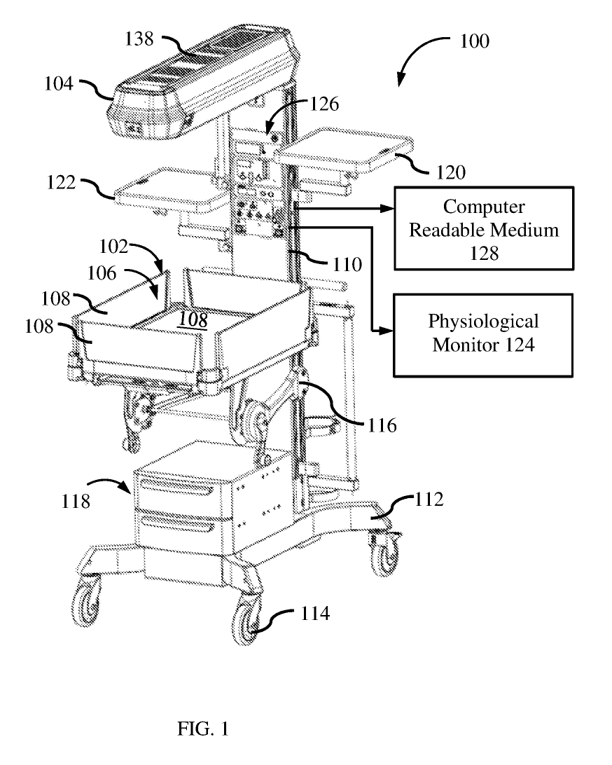

Referring to FIG. 1, this figure illustrates a perspective view of an exemplary infant care system 100 in accordance with an embodiment. The infant warming apparatus 100 includes an infant holding unit 102 for holding an infant. The infant is placed in the infant holding unit 102 by a medical expert or a nurse. The infant holding unit 102 depicted is a bed for warming the infant. The bed is warmed using a heater canopy 104 positioned overhanging above the infant holding unit 102. A heating region 106 is formed in an area around the infant within which the infant care system 100 controls the desired temperature level. In general, the heating region 106 is defined as the space within the infant holding unit 102. Additionally one or more walls 108 further define the heating region 106. The walls 108 may be selectively movable such as to allow access by a clinician to the infant. In other embodiments, walls may have different configuration including one or more arm ports through which a clinician can reach the infant so as to facilitate maintaining the heating region 106 while the clinician cares for the infant.

The heater canopy 104 and the infant holding unit 102 are coupled to a supporting unit 110. In an embodiment the heater canopy 104 and the infant holding unit 102 are integrated to the supporting unit 110 and thus extend outwardly. The supporting unit 110 is coupled to a base unit 112 having a plurality of wheels 114. These wheels 114 enable the infant care system 100 to be moved from one place to another. Moreover as depicted in FIG. 1 the infant care system 100 also includes an adjustment unit 116 for moving the infant holding unit 102 for example tilting of the infant holding unit 102.

The infant care system 100 also includes storage units 118, 120 and 122 used for storing equipments for assistance, medicines, and other diagnostic equipments for monitoring and providing care to the subject. For example the infant care system 100 may include a physiological monitor 124. In other embodiments, a portion of the physiological monitor 124, such as physiological transducers are disposed within the heating region 106, or otherwise extend into the heating region 106, and attached to the infant to acquire physiological signals from the infant. Non-limiting examples of the physiological monitor 124 that may be used in the infant care system 100 include electrocardiograph (ECG), electroencephalograph (EEG), SPO2, temperature, and non-invasive blood pressure (NIBP). However, it is understood that these are merely exemplarily and many other types of physiologic monitors and patient monitoring devices may be used in the presently disclosed manner. For example, patient monitoring systems or breathing assistance devices or ventilators may be conveniently placed on these storage units and connected to the infant conveniently for infant's medical assistance.

Further the infant care system 100 includes a control unit 126 that enables a user to control various operations of the infant care system 100. The control unit 126 may include any of a variety of known controllers, microcontrollers, or microprocessors. The control unit 126 is communicatively connected to a computer readable medium 128 upon which computer readable code is stored. The computer readable medium 128 may be any of a known variety of computer memory, including, but not limited to, non-volatile memory such as EEPROM, flash memory, optical memory, or removable data storage. The computer readable medium 128 stores computer readable code that includes instructions that when executed by the control unit 126 causes the controller to perform functions and operations as disclosed herein.

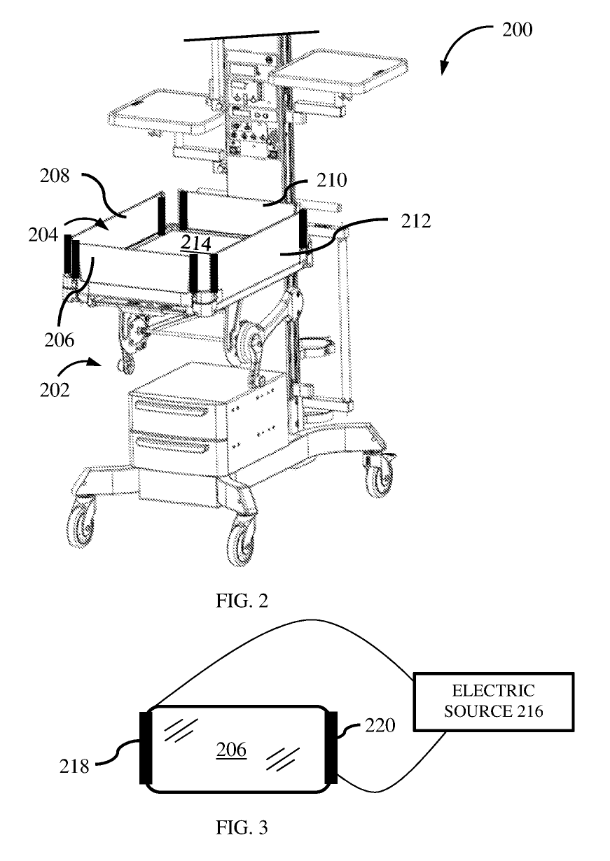

FIG. 2 is a schematic representation of an infant care system 200 according to an embodiment. The infant care system 200 shown herein is an infant warming system according to an exemplary embodiment and hence the infant care system 200 may also include an incubator or any other similar device without deviating from the scope of this disclosure. The infant care system 200 includes a supporting structure 202 holding an infant enclosure 204. The infant enclosure 204 is formed using a plurality of walls such as a wall 206, a wall 208, a wall 210, a wall 212 and a wall 214. The infant enclosure 204 also includes a bed placed on the wall 214 for holding the infant thereon. In an embodiment the plurality walls may be composed of carbon fiber. In another embodiment the plurality of walls may be made of a conductive film of carbon nanotubes on a substrate. The substrate may be but not limited to an acrylic substrate, a polyethylene terephthalate and so on. In yet another embodiment the walls may be composed of carbon fibers in the form of silver nanowires. These silver nanowires act as conductive coating layer on the walls. The plurality of walls (hereinafter referred to as walls) is connected to an electric source 216. For instance the wall 206 may be connected to the electric source 216 as illustrated in FIG. 3. FIG. 3 illustrates a positive terminal 218 and a negative terminal 220 provided at two sides of the wall 206 which are then connected to the electric source 216. In another embodiment the positive terminals and the negative terminals may be arranged along the walls in a different configuration to supply the power from the electric source 216. In an embodiment the electric source 216 provides power at the range of 400 W to 500 W. The electric source 216 supplies power to the wall 206 so that heat energy is generated on the wall 206. Similarly the other walls such as the wall 208, the wall 210, the wall 212 and the wall 214 are also connected to an electric source for instance the electric source 216. The heat energy is generated in the form infrared radiation. In an embodiment the wall 208, the wall 210, the wall 212 and the wall 214 may be connected to separate electric sources other than the electric source 216. The heat energy from all the walls results in creating a warm atmosphere within the infant enclosure 204. Thus the surrounding around the infant may be warm. The walls may have an efficient thermal response and hence the heat energy may be generated faster. Due to faster thermal response even distribution of heat within the infant enclosure is achieved. Further due to conduction and convection within the infant enclosure 204 the thermal losses may be less and thus less power consumption is achieved. The temperature of the atmosphere is controlled within a predefined range by regulating the power supplied to the walls by the electric source such as the electric source 216. The predefined range of the temperature may be temperature according to the standards defined for warming the infants. It may be envisioned that the walls may be composed of any other materials other than carbon fiber which are capable of generating heat energy using the power received without deviating from the scope of this disclosure. The walls may not have a hot surface due to generation of heat energy and thus may be safe for the operator and the infant placed in the infant enclosure 204.

In an embodiment the walls may be transparent so that the infant if placed in the infant enclosure 204 is visible to an attender. In an embodiment the wall 206 may have a length of about 500 mm and the wall 208 may have a length of about 650 mm. As illustrated in FIG. 2, the infant enclosure 204 is a rectangular enclosure formed within the walls 206-214 and in an open condition. However it may be appreciated that the infant enclosure may have a different configuration with a completely closed structure according to other embodiments. This closed structure can be opened to place the infant within the same for providing a warm atmosphere. Alternatively the infant enclosure may have different configuration such as but not limited to square and an ellipse configuration.

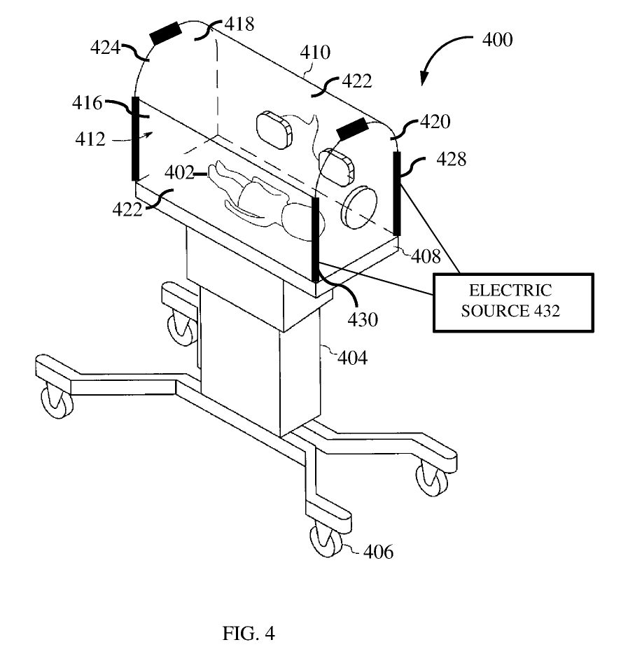

FIG. 4 illustrates an incubator 400 configured to house an infant 402, such as a premature infant, is illustrated according to an exemplary embodiment. Typically, the incubator 400 includes a base 404, generally mounted on a series of rollers 406. In addition, a support plate 408 may be mounted on the base 404, wherein the support plate 408 may be configured to support an infant 402. The incubator 400 may also include a hood 410 mounted on the base 404 to form an incubation chamber 412, wherein the incubation chamber 412 may be configured to provide a controlled environment isolated from the surrounding environment.

Furthermore, the hood 410 may include access portals 414 to facilitate access to the infant 402 without significantly altering the controlled environment within the incubation chamber 412. Also, one or more sensors (not shown) may be disposed on the infant 402. As will be appreciated by one skilled in the art, the one or more sensors may be configured to measure physiological parameters, such as vital signs of the infant 402. For example, the vital signs of the infant 402 may include a temperature, a pulse, an electrocardiogram, or a blood oxygen level. The hood 410 has multiple walls such as a wall 416, a wall 418, a wall 420, a wall 422 and a wall 424. These walls may be composed of carbon fiber. In another embodiment the plurality of walls may be made of a conductive film of carbon nanotubes on a substrate. The substrate may be but not limited to an acrylic substrate, a polyethylene terephthalate and so on. In yet another embodiment the walls may be composed of carbon fibers in the form of silver nanowires. These silver nanowires act as conductive coating layer on the walls. The plurality of walls (hereinafter referred to as walls) is connected to an electric source 216.

As illustrated in FIG. 4 a positive terminal 428 and a negative terminal 430 are provided at two sides of the wall 420 which are then connected to an electric source 432. In another embodiment the positive terminals and the negative terminals may be arranged along the walls in a different configuration to supply the power from the electric source 432. The electric source 432 as described earlier in conjunction with FIGS. 2 and 3 supplies power to the wall 420 so that heat energy is generated on the wall 420. Similarly the other walls such as the wall 416, the wall 418, the wall 422 and the wall 424 are also connected to an electric source for instance the electric source 432. The heat energy is generated in the form infrared radiation. In an embodiment the wall 416, the wall 418, the wall 422 and the wall 424 may be connected to separate electric sources other than the electric source 432. The heat energy from all the walls results in creating a warm atmosphere within the incubation chamber 412. It may be appreciated that the incubation chamber 412 is an exemplary structure so other configurations of the incubation chamber can be used within the scope of this disclosure.

From the foregoing, it will be appreciated that the above disclosed infant care system for providing support to premature infant provides numerous benefits to healthcare enterprises, such as a convenient design that enables easy accessibility for the infant. In the system a heater canopy normally used for providing heat to an infant enclosure is eliminated thereby the infant is accessible to the attender for various operations using medical devices such as an x-ray device. Moreover the walls capable of generating heat energy used in this infant care system facilitate even distribution of heat within the infant enclosure. These walls even though act as heaters yet they are transparent providing visibility to the attender for monitoring the infant. The walls also have efficient thermal response and reduced thermal losses due to conduction and convection.

This written description uses examples to disclose the invention, including the best mode, and also to enable any person skilled in the art to practice the invention, including making and using any computing system or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An infant care system, wherein the infant care system comprises:
a supporting structure;
an infant enclosure assembled onto the supporting structure, the infant enclosure capable of holding an infant, wherein the infant enclosure comprises a plurality of walls for forming the infant enclosure, wherein the plurality of walls is capable of providing heat energy into the infant enclosure for the infant; and
an electric source electrically connected to the plurality of walls for providing power to the plurality of walls for generating the heat energy.

2. The infant care system of claim 1, wherein the plurality of walls is composed of carbon fiber material.

3. The infant care system of claim 1, wherein the electric source provides power at the range of 400 W-500 W.

4. The infant care system of claim 1, wherein the infant enclosure comprises a bed capable of having the infant placed thereon.

5. The infant care system of claim 4, wherein the plurality of walls are arranged around the bed, wherein the bed has a rectangular configuration.

6. An infant enclosure for an infant care system, the infant enclosure comprising:
an infant enclosure assembled onto a supporting structure of the infant care system, the infant enclosure capable of holding an infant, wherein the infant enclosure comprises a plurality of walls for forming the infant enclosure, wherein the plurality of walls is capable of providing heat energy into the infant enclosure for the infant; and
an electric source electrically connected to the plurality of walls for providing power to the plurality of walls for generating the heat energy.

7. The infant enclosure of claim 6, wherein the plurality of walls is composed of carbon fiber material.

8. The infant enclosure of claim 6, wherein the electric source provides power at the range of 400 W-500 W

9. The infant enclosure of claim 6, wherein the infant enclosure comprises a bed capable of having the infant placed thereon.

10. The infant enclosure of claim 9, wherein the plurality of walls are arranged around the bed, wherein the bed has a rectangular configuration.

11. The infant care system of claim 1, wherein the plurality of walls is transparent.

12. The infant enclosure of claim 6, wherein the plurality of walls is transparent.

13. The infant care system of claim 1, wherein the heat energy is infrared radiation.

14. The infant enclosure of claim 6, wherein the heat energy is infrared radiation.

15. A method of warming an infant positioned in an infant care system, comprising:
providing power to a plurality of walls surrounding the infant, the walls electrically connected to an electric source; and
generating heat energy in the form of infrared radiation.

16. The method of claim 15, further comprising:
regulating with a controller the power provided by the electric source to maintain the temperature of the infant care system within a predefined range.

17. The method of claim 15, wherein the plurality of walls is composed of carbon fiber material.

18. The method of claim 15, wherein the step of providing power to a plurality of walls includes providing power at the range of 400 W-500 W.
